(19) United States
(12) Patent Application Publication
(10) Pub. No.: US 2007/0168368 A1
(43) Pub. Date: Jul. 19, 2007

(54) Data Structures and Methods for Genealogical Research

(76) Inventor: Joseph S. Stone, Santa Rosa, CA (US)

Correspondence Address: EDWARD S. SHERMAN, ESQ., 3554 ROUND BARN BLVD., SUITE 303, SANTA ROSA, CA, 95403, US

(21) Appl. No.: 11/565,977

(22) Filed: Dec. 1, 2006

Related U.S. Application Data
(60) Provisional application No. 60/741,827, filed on Dec. 2, 2005.

(51) Int. Cl. G06F 7/00

(52) U.S. Cl. 707/100

(57) ABSTRACT

Improved methods of genealogical research utilize databases with fields that more uniquely identify individuals and relationships for the purpose of tracing and identifying ancestors or living relations. In selected embodiments, the fields represent genetic markers on the mitochondrial DNA and biographic or historical data useful in tracing matriarchal heritage. In other embodiments, the fields represent ownership records or conveyances of property between related or unrelated individuals. In other aspects of the invention methods of searching account for the evolution of geographic and political divisions in searching genealogical database, as well as the alternative spelling of names and nickname.

### CROSS REFERENCE TO RELATED APPLICATION

The present application claims priority to the U.S. provisional application having Ser. No. 60/741,827 entitled “Data Structures and Methods for Genealogical Research”, filed on Dec. 2, 2005, which is incorporated herein by reference.

### BACKGROUND OF INVENTION

This invention relates to the organization, processing and searching of genealogical data. Particularly, this invention relates to improvements to the storage and retrieval of genealogy information, includes methods of inputting and using information from historical data and/or genetic characteristics derived from DNA testing to expand the search capabilities for genealogists.

The research into genealogical records is a popular hobby, as well as legal research to find un-named heirs.

Today's worldwide genealogy data records environment can be summarized in general terms as comprising hundreds of millions of relatively large public record sets in non-lineage-linked format, mostly on paper or microfilm, plus proportionately much smaller collections of lineage-linked names, mostly held by individual persons. The smaller collections are increasingly in digital and computer readable format. These smaller collections of relatives' names are generally derived in part for family non-public records, plus extracts from any number of larger public record sets. There are huge national collections of records, such as the U.S. censuses, that may contain hundreds of millions of names. Other national records include census, social security, military and Emigration, immigration and naturalization records, including Passports. At the state level, there are the usual birth; marriage; death; Tax; Voter registration; Wills and probate records. At the local or county level, one might find Land and homestead records/deeds, burial, and court records. Other useful personal or commercial records might include, without limit: Adoption records; Baptism or christening records; Biographies and biographical profiles (as in Who's Who, etc.); Cemetery records and tombstones; City directories and telephone directories; Daughters of the American Revolution records; Diaries, personal letters and family Bibles; Marriage and divorce records; Medical records; Newspaper columns; Obituaries; Occupational records; Oral history; Photographs; School and alumni association records; and Ship passenger lists.

However, many genealogical researchers eventually reach a limit of tracing their family history or connections that leave them unsatisfied, wishing to delve further back in their family history, discover living relatives, or determine if they are related to a particular living or deceased individual.

The success of the researcher meeting their objective is highly dependent on the ancestry/ethnicity of the subjects, as well as their ancestor's geographic dispersion. Success is also dependent on existence, or lack thereof, of extant records that have been passed through multiple generations. For example, an individual whose ancestors were held in peony, i.e. as slaves, will have a very difficult time tracing their ancestry due to a lack of available records.

A greater problem for the genealogical researcher using computerized databases, or programs that can link to and abstract data from computerized records, is the inconsistency and errors in these records. Another problem that frustrates the researcher in meeting their objective is differences in spelling of names, as might change fashion through generations, or ancestors being called by their nickname or abbreviated name in some records that contemporaneously record information about the same person.

Although genetic markers in DNA are a successful tool in the scientific research of population genetics, the application of this tool to the genealogist has been limited.

### SUMMARY OF INVENTION

In the present invention, the first object is to extend the capability for computerized genealogical research.

Another object of the invention is to enable the identification of living kin related through a maternal line.

Another object of the invention is to enables the identification of living kin related through a paternal line.

The above and other objects of the invention are met by providing data structure and graphic users interface for accessing and searching such databases that force the consistent entry of data.

Other aspects of the invention are met by providing a search capability that accounts for the historical variation of geographic regions, territories, districts, counties, provinces, states or political boundaries.

Other aspects of the invention are met by providing a search capability that accounts for genetic markers of the named person's mitochondrial DNA and the names of matriarchal ancestors and their siblings.

Other aspects of the invention are met by providing a search capability that accounts for genetic markers of the named person's DNA and the names of paternal ancestors and their siblings.

Other aspects of the invention are met by providing a search capability that accounts for the name of the person conveyed in a slave or related transaction at least one of a date and a geographic or jurisdictional designation associated with the transaction, including emancipation.

Other aspects of the invention are met by providing a search capability that accounts for multiple alternative names or spellings of the first or last name of a living person or ancestor.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is an illustration of an exemplary graphic user interface that implements multiple embodiments of the invention.

FIG. 2 is example of the data fields found and associated in an expanding geographic designation data structure.

FIG. 3 is a family tree to illustrate the application of a data structure and search algorithm that utilizes mtDNA.

FIG. 4 is a family tree to illustrate the application of a data structure and search algorithm that utilizes DNA on the Y-chromosome.

### DETAILED DESCRIPTION

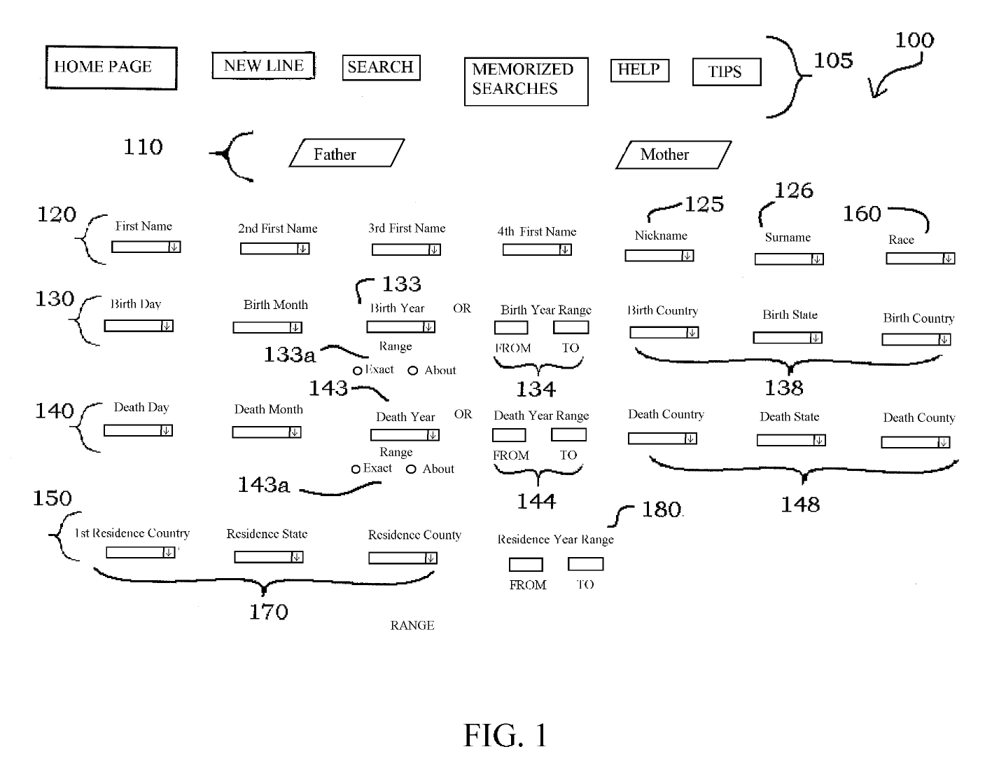

In accordance with the present invention, FIG. 1 is a graphic user interface (GUI) 100 for the computer implementation of various embodiments of the invention. The GUI contains imputer fields via drop down menus for entering or searching data, as well as navigation buttons for moving to or displaying related GUI's and radio buttons for entering data. The GUI may be used to search a local computer, a server or a plurality of computers and databases, such as might be available over the internet or other data communication networks.

A researcher that builds or contributes to the database by abstracting information from paper historical records, newspaper accounts and the like might also use such a GUI. In the most preferred implementation of the invention, the combined elements of each embodiment would be available to the genealogical researcher. Many researchers are in fact building the database by contributing information on the search subject, that the point of backward tracing to find ancestors, as well as information known by the individual of living or recently deceased kin, such a parent or grandparent.

Referring now to FIG. 1, a top navigation bar region 105 contains a plurality of buttons that either provide instructions to the users (i.e. HELPS AND TIPS), or switch the mode of operation or function (HOME PAGE, NEW LINE, SEARCH and MEMORIZED SEARCHES). The next set of control buttons are arranged in row 110, for “FATHER” and “MOTHER” allowing the researcher to enter information about either parent of the subject being described or characterized with the remaining input fields on the pages, that is those arranged in rows labeled 120, 130, 140 and 150. It should be appreciated that the GUI 110 is only exemplary as a different layout or multiple GUI pages could be used to enter the same information.

Row 120 has a plurality of drop down list boxes for entering data in a name field of the person being identified or described in GUI 100. Name field have drop-down menus that limit responses to exact spelling, or the opportunity to state that particular information is unknown. A name field in any database described herein may be a field for a first name field, a surname or last name, a middle name and a nickname and/or any combination of the aforementioned. As the same individual might be known by multiple first names, or first names of slightly different spellings a plurality of drop down list boxes are arrayed for example in entering up to four alternative first names. A nickname may be entered as well of, or in place of a more formal first name using drop down list box 125. At least one drop down list box 126 is also provided for entering a surname 126. The plural first name drop down lists, that is the first, second, third and fourth name buttons are provided to enter into a data structure for searching a first name field for the subject, a last name field for the subject, and a secondary first name field for the subject. The secondary name field for a subject contains a data record that is a variant of the data record in the primary first name field for the subject. The secondary name fields are structured as drop down lists to force the user to consider and implement known alternative spellings, as well as to enter more conventional spellings, thus preventing the entry of spurious information through keyboard entry errors. This embodiment of the invention improves genealogical searching by enforcing a consistency of data input, yet allows for flexibility in that oral traditions may vary from older extant records. Thus, this database maintains a data structure of alternative names and spellings, as well as nicknames that might be used. When the user selects or starts to spell a name the alternative become available in the drop-down menu fields.

Another embodiment of the invention to improve genealogical searching is to expand the options for selecting names in the drop down lists described above. Such a method might be available to the individual researcher as well as a system/database administrator. The first step in the method is to generate input fields in a GUI (graphic user interface) to receive a first name not in an existing drop down list box or button, the next step is to type or otherwise enter the letters/characters of the first name, which is then received in the database. The next step in the process is for the computer to check the spelling of first name against a database of primary and secondary first names, then if the proposed name is not found in the existing database, the computer software is operative to generate input fields in the GUI for at least one of expanding the secondary names in the database, adding a first name record to the database and selecting a primary name in the database. If there is an exact match with either the primary or the secondary names then the GUI prompts the user to select this name. If there is not an exact match, the user has the option of adding a new name to the list in the drop-down list. If known, the individual's race is optionally entered in drop down list 160.

Row 130 includes a plurality of input interfaces to characterize the date and location of the subject's birth. Row 130 is subdivided into a series of drop down list 138 to optionally enter the birth location as either a country, state, county, or other political subdivision.

Date input fields allow for the entry of an exact day, via separate drop down list buttons for the day, month and year. Alternatively, when there is less certainly, only the year need be entered. Database field for dates permits an exact date or an approximate date, thus accounting for the possibility of a two-year error arising from the inaccuracy of recording and reporting ten-year census records in the U.S.A. The entry of the year may be selected as either exact (such as might be found on a birth certificate) or approximate (such as might apply to a census record) by clicking on a radio style button such as 133a for birth year 133. Likewise, the entry of the year of death may be selected as either exact or proximate by clicking on a radio style button 143a for characterizing the death year by button 143. Alternatively, using buttons 134, a range of birth years may be specified. Using buttons 144, a range of the year of death may be specified.

Row 140 includes a plurality of input interfaces to characterize the date and location of the subject's death, if it has occurred. Row 140 is subdivided into a series of drop down lists 148 to optionally enter the death location as either a country, state or county or other political subdivision.

Row 150 includes a plurality of input interfaces to characterize what may be known about the residence or domicile of the subject during their lifetime. Row 150 is subdivided into a series of drop down lists 170 to optionally enter the location of residence as either or a country, state or county or other political subdivision. Row 150 is further subdivided into a series of input fields 180 to enter the date range of residence for the subject.

Another embodiment of the invention to improve genealogical searching is a branched geographic database. Geographic designations or indicators include country and any political or judicial subdivisions therewith (i.e. state, commonwealth, county, parish, as well as any chancery, probate or district court).

The geographic names of regions and places typically changes over time. Historical documents typically reflect the correct name for the place at the time the record or document was created. Thus for example, the same individual if born in a town in the Commonwealth of Virginia that eventually became part of the State of West Virginia might have on their birth certificate the place of birth as Virginia, but West Virginia recorded as the place of birth in the death certificate if they were born and died in the same location. However, a sibling born in the same location while it was still Virginia might have Virginia listed on their death certificate as the place of birth, if they died in another state, their living kin having record the verbal record they relied upon that their parent or grandparent was born in Virginia. Accordingly, it is unlikely that a researcher would realize the first example is the same person, or that the first example and second example are siblings. Accordingly, in a preferred embodiment of the invention when a researcher enters the subjects name, date of birth/death (or date range) along with the location of this life cycle event the search algorithm would take into account that during the subject time period entered in the date search field the geographic description of the life cycle event would have an alternative and equally valid description. The search algorithm would be generated to include this alternative by look up in a data structure having fields for a first geographic designation, a second geographic designation, at least one date and at least one alternative geographic description. After look up from this data structure the actual search for the individual would be based on matching to a data structure representing the individual that includes data fields for at least the first or last name of the subject, the subjects primary geographic designation and the subjects secondary geographic designation derived from the subjects primary geographic designation based on a prior history.

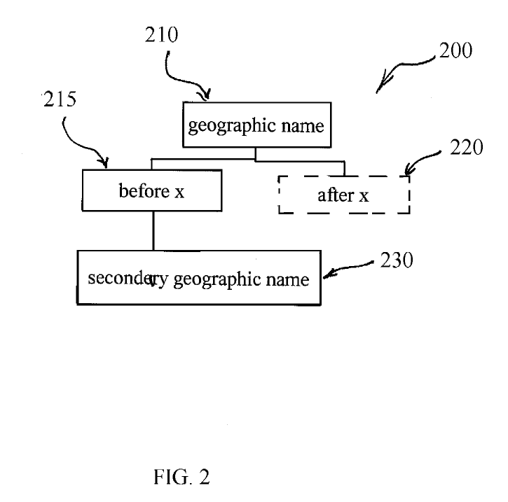

The relationship of the fields in portions of this database is shown in FIG. 2 as a series of interrelated data fields 200. The database has a least one record field 210 for a primary geographic name, such as that might be matched with the user's entry in drop down lists 138, 148 and 170 in the GUI 100 of FIG. 1. The data structure then has at least one date related field 215 which contains data representing when at least a portion of the geographic region in field 210 was known by a different, that is a secondary name, in field location 230. Optionally the data structure contains alternative fields such as 220 that might represent a different date when the geographic region in field 210 was known by a tertiary name.

Another embodiment of the invention to improve genealogical searching utilizing information derived from mitochondrial (mt)DNA. As mtDNA is inherited only through the mother, persons related by a common ancestor in the line of mother-grandmother-great grandmother-great great grandmother etc. will share the same mtDNA.

With respect to genealogical research, mtDNA and DNA are characterized by many unique regions not associated with protein synthesis, regulation and gene expression but known to uniquely vary between individuals. Each such particular region is called a marker. Each marker may have one or more characteristics values, representing a specific sequence of nucleotides in the genome at a particular location. Individuals have a greater probability of being related if more or all of the known genetic markers have the same value. Once a person has characterized their own mtDNA, they can add to a searchable database using, among other information, the name or identity of each marker and the value of the marker for each named relation they know of in their maternal line. Thus, research to find or identify siblings of ancestors in the subject's maternal line, and possibly living relatives descended maternally from these ancestors, can be accomplished by searching a common database, wherein a large number of individuals have entered parameters of their own mtDNA markers, which would then be attributed to the known ancestors in their maternal line.

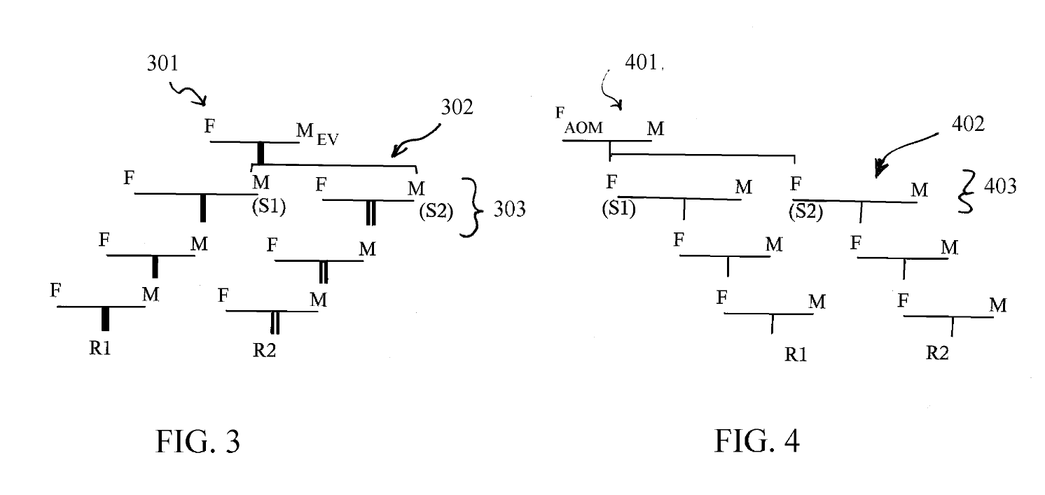

Such a database would contain data fields for the subject's name, a plurality of genetic markers of the named person, a value associated with each genetic marker, the name of a matriarchal ancestor of the subject. In preferred embodiments, the data structure and search algorithm generated therefrom will also include data fields linking multiple named subjects and the relationships. In more preferred embodiments, the data structure and search algorithm generated therefrom will also include data fields for adding the name of female siblings of the maternal line, as descendents of female siblings, be they male or female, would inherit largely the same mtDNA (other than for mutations that are known to occur a very low frequency over tens or hundreds of generations). This principle is illustrated schematically in FIG. 3 as a theoretical abstract of a portion of a database showing the male (F for father) and female (M for Mother) parent at each generation and their offspring that would have the common mtDNA markers. Although the mtDNA passes to both male and female offspring only the female offsprings are shown at each generation level. This is because only the female is capable of passing the mtDNA to the next generation. At the bottom, or living generation, are two research subjects R1 and R2 that have a match of mtDNA markers. R1 has built a multi-generation linked family tree 301 from a variety of records before using mtDNA data, shown by a solid bold line linking parents to children. Family tree 301 extends from the common maternal ancestor, Mₑᵥₑ, to R1. However, R2 has built a multi-generation linked family tree 302 that does not extend to Mₑᵥₑ, but is one generation removed. Fortunately, R1's tree included a maternal ancestor, designated S1, who was known to have a sibling S2. As S1 and S2 have the same mother, Mₑᵥₑ, they share the same mtDNA, which is passed on to R1 and R2. Accordingly as the both tree 301 and tree 302 at generation level 303 have a female siblings that are likely to be the same person based on name and preferably at least one of age, place of birth, death or residence, R2 can then extend the knowledge of her ancestry to reach the generation of Mₑᵥₑ, as well as to add branch 301 contributed by R1. Thus, finding both a match in mtDNA and at least a common pair female sibling in their maternal lines R1 and R2 can discover they are related. In more preferred embodiments such matriarchal ancestor database includes record fields for date and/or lifecycle event such as the birth, death, marriage, religious ceremony, divorce, place of birth, death, and/or marriage, property acquisition or bequest, or mere domicile or place of residence. In the most preferred embodiments, the matriarchal ancestor database includes record fields for the names of male siblings.

Another embodiment of the invention to improve genealogical searching utilizes information derived from DNA of the Y chromosome of male subjects or the male siblings of subjects. Such a database would contain data fields for the subject's name, a plurality of genetic markers of the named person, a value associated with each genetic marker, the name of a patriarchal ancestor of the subject. In preferred embodiments, the data structure and search algorithm generated therefrom will also include data fields linking multiple named subjects and the relationships. In preferred embodiments, the data structure and search algorithm generated therefrom will also include data fields for adding the name of male siblings of the paternal line, as only male descendents of male siblings would inherit largely the same DNA on the Y-chromosome, other than for mutations that are known to occur a very low frequency over tens or hundreds of generations. This principle is illustrated schematically in FIG. 4 as a theoretical abstract of a portion of a database showing the male (F for father) and female (M for Mother) parent at each generation and their offspring that would have the common Y-chromosome DNA markers. As the Y-chromosome DNA only passes to male offsprings, the female offspring are not shown to simplify the diagram. At the bottom, or living generation, are two research subjects R1 and R2 that have a match of Y-chromosome DNA markers of either themselves or a male sibling. R1 has built a multi-generation linked family tree 401 from a variety of records before using DNA data, shown by a solid bold line linking parents to children. Family tree 401 extends from F_{adam} to R1. However, R2 has built a multi-generation linked family tree 302 that does not extend to F_{adam}, but one generation removed. Fortunately, R1's tree included a paternal ancestor, designated S1, who was known to have a male sibling S2. As S1 and S2 have the same Father, F_{adam}, they share the same DNA, which is passed on to both R1 and R2. Accordingly as the both tree 401 and tree 402 at generation level 403 have a pair of male siblings that are likely to be the same person based on name and preferably at least one of age, place of birth, death or residence, R2 can extend the knowledge of his or her ancestry to now reach the generation of F_{adam}, as well as branch 401 contributed by R1. Thus finding both a match in Y-chromosome DNA and at least a common pair male sibling in their paternal lines R1 and R2 can discover they are related. In more preferred embodiments such paternal ancestor database includes record fields for date and/or lifecycle event such as the birth, death, marriage, religious ceremony, divorce, place of birth death and/or marriage, or mere domicile or place of residence. In most preferred embodiments, the patriarchal ancestor database includes record fields for the names of female siblings. Such a database would contain data fields for the subjects name, a plurality of genetic markers of the named person, a value associated with each genetic marker, the name of a sibling of an ancestor of the subject.

Another embodiment of the invention to improve genealogical searching utilizes information historical records that record the conveyance or emancipation of slaves. Such records can be founds in ancient wills, courthouse records of sales, contemporaneous newspaper accounts and the like. Such a database would contain data fields for the conveyor's name, the receiver's name, at least a first or last name of the person conveyed or emancipated, and at least one of a date and a geographic or jurisdictional designation associated with the transaction.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. A data structure for the search and retrieval of genealogical information comprising one or more individual data records having fields for:
a) the subject's name,
b) the subject's primary geographic designation,
c) the subject's secondary geographic designation derived from the subject's primary geographic designation based on prior history.

2. A data structure according to claim 1 further comprising a data field for:
a) the year of a life cycle event associated with at least one of the primary and secondary geographic designation.

3. A data structure according to claim 1 further comprising a data field for:
a) A range of years of a life cycle event associated with at least one of the primary and secondary geographic designation.

4. A data structure according to claim 1 further comprising a data field for:
a) A range of dates of a life cycle event associated with at least one of the primary and secondary geographic designation.

5. A method of initiating a computer implemented genealogical database search wherein the search criteria are entered via a graphic user interface (GUI), the method comprising the steps of:
a) generating a first input fields in a GUI to receive at least one of the first and last name,
b) receiving at least one of the first and last name via the GUI in the first input field,
c) generating a second input fields in a GUI to receive at least the year or years of a live cycle event,
d) receiving the date of the life cycle event in the second input field via the GUI,
e) generating a third input fields in a GUI to receive a primary geographic designation associated with a date in the second input field,
f) receiving a primary geographic designation in the third input data field,
g) determining a second geographic designation from the second and third data field,
h) displaying the secondary geographic designation in the GUI.

6. A method according to claim 5 wherein the life cycle event is selected from the group consisting of birth, baptism, marriage, death, and the acquisition or transfer of property by sale, gift or inheritance.

7. A method according to claim 5 further comprising the steps of:
a) generating a fourth input field for receiving the type of the life cycle event associated with the date in the second input field,
b) receiving the type of the life cycle event in the fourth input data field.

8. A method according to claim 5 further comprising the step of generating in the GUI an input field for selecting at least one of the first and second geographic designation fields for inclusion in a genealogical data search.

9. A method according to claim 5 wherein the step of generating a second input fields in a GUI to receive at least the year or years of a live cycle event includes providing subdata field for receiving the exact date of the life cycle event.

10. A method according to claim 5 wherein the step of generating a second input fields in a GUI to receive at least the year or years of a live cycle event includes providing subdata field for each of the earliest and the last year of the life cycle event.

11. A method according to claim 5 wherein the step of generating a second input fields in a GUI to receive at least the year or years of a live cycle event includes providing subdata field for each of the earliest and the last exact date of the life cycle event.

12. A method of initiating a computer implemented genealogical database search wherein the search criteria are entered via a graphic user interface (GUI), the method comprising the steps of:
a) generating input fields in a GUI to receive at least one of a primary first name and a last name,
b) receiving the primary first or last name via the GUI,
c) comparing the spelling of the primary first or last name against a database of primary and secondary first or last names,
d) generating input fields in the GUI for selecting from one or more alternatives first or last names as a secondary name.

13. A method according to claim 12 further comprising the step of generating an input field to selectively include or exclude the secondary names in the search.

14. A method according to claim 12 further comprising the step of generating an input field to selectively switch the primary and secondary names in the search.

15. A method according to claim 12 further comprising the step of generating an input field to add new secondary names in the database and associate the secondary name with a primary name.

16. A method according to claim 12 further comprising the steps of:
a) generating a second input fields in a GUI to receive at least the year or years of a live cycle event,
b) receiving the date of the life cycle event in the second input field via the GUI,
c) generating a third input fields in a GUI to receive a primary geographic designation associated with a date in the second input field,
d) receiving a primary geographic designation in the third input data field,
e) determining a second geographic designation from the second and third data field,
f) displaying the secondary geographic designation in the GUI.

17. A data structure for the search and retrieval of genealogical information comprising one or more individual data records having fields for:
a) a primary first name field for the subject,
b) a primary last name field for the subject,
c) a secondary name field for the subject for containing a data record that is a variant of the data record in the primary first or last name field for the subject.

18. A data structure according to claim 17 further comprising secondary name fields for the subject for containing a data record that is a variant of the data record in the primary first and last name field for the subject.

19. A data structure according to claim 17 further comprising:
a) the subject's primary geographic designation,
b) the subject's secondary geographic designation derived from the subject's primary geographic designation based on prior history.

20. A data structure according to claim 19 further comprising:
a) the year of a life cycle event associated with at least one of the primary and secondary geographic designations.
